(19) United States
(12) Patent Application Publication
(10) Pub. No.: US 2005/0003988 A1
(43) Pub. Date: Jan. 6, 2005

(54) Enzyme bleach lipophilic fluid cleaning compositions

(75) Inventors: Ivan Maurice Alfons Jan Herbots, Wetteren (BE); Kristel Maria Denoodt, Langdorp (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/874,876

(22) Filed: Jun. 23, 2004

Related U.S. Application Data
(60) Provisional application No. 60/483,368, filed on Jun. 27, 2003.

(51) Int. Cl. C11D 7/18

(52) U.S. Cl. 510/375

(57) ABSTRACT

The present invention relates to kits that can be used to provide lipophilic fluids with bleaching capabilities via enzymatic action, and lipophilic fluid cleaning compositions having bleaching capabilities and processes of making and using same. Such compositions provide the cleaning benefits of typical lipophilic solvents and additional cleaning benefits that include, but need not be limited to, bleaching.

### CROSS-REFERENCES TO RELATED APPLICATIONS

This application claims priority under 35 U.S.C. § 119(e) to U.S. Provisional Application Ser. No. 60/483,368 filed Jun. 27, 2003.

### FIELD OF THE INVENTION

The present invention relates to kits that can be used to provide lipophilic fluids with bleaching capabilities, lipophilic fluid cleaning compositions and processes of making and using same.

### BACKGROUND OF THE INVENTION

Certain fabric types and constructions require dry cleaning. Dry cleaning typically involves the use of non-aqueous, lipophilic fluids as the solvent or cleaning solution. While cleaning with lipophilic fluids eliminates or minimizes fabric damage, lipophilic fluids have poor hydrophilic and/or combination soil removal capabilities. However, such soils may be efficiently removed by cleaning additives. Unfortunately cleaning additives, such as bleaching materials are sparingly soluble, and ineffective in lipophilic fluids as such materials deposit unevenly on fabrics thus causing fabric damage. As a result, pre-treating and/or pre-spotting compositions are used to remove tough soils. As, pre-treating and/or pre-spotting are time consuming and generally limited to spot removal there is a need for compositions that can be used to provide a lipophilic fluid with bleaching capabilities, lipophilic fluid cleaning compositions having bleaching capabilities and processes of making and using same.

### SUMMARY OF THE INVENTION

The present invention relates to kits that can be used to provide lipophilic fluids with bleaching capabilities via enzymatic action, and lipophilic fluid cleaning compositions having bleaching capabilities and processes of making and using same.

These and other aspects, features and advantages will become apparent to those of ordinary skill in the art from a reading of the following detailed description and the appended claims.

### DETAILED DESCRIPTION OF THE INVENTION

Definitions

The term “fabrics” and “fabric” used herein is intended to mean any article that is customarily cleaned in a conventional laundry process or in a dry cleaning process. As such the term encompasses articles of clothing, linen, drapery, and clothing accessories. The term also encompasses other items made in whole or in part of fabric, such as tote bags, furniture covers, tarpaulins and the like.

The term “soil” means any undesirable substance on a fabric. By the terms “water-based” or “hydrophilic” soils, it is meant that the soil comprised water at the time it first came in contact with the fabric article, or the soil retains a significant portion of water on the fabric article. Examples of water-based soils include, but are not limited to beverages, many food soils, water soluble dyes, bodily fluids such as sweat, urine or blood, outdoor soils such as grass stains and mud.

As used herein, the articles a and an when used in a claim, for example, “an emulsifier” or “a peracid precursor” is understood to mean one or more of the material that is claimed or described.

As used herein “in use version” refers to embodiments of Applicants' cleaning composition that have not substantially undergone the enzymatic reaction that generates peracid.

As used herein “finished in use versions” refers to embodiments of Applicants' cleaning composition that have undergone the enzymatic reaction that generates peracid to a sufficient extent to obtain the desired level of peracid required for effective cleaning.

Unless otherwise noted, all component or composition levels are in reference to the active level of that component or composition, and are exclusive of impurities, for example, residual solvents or by-products, which may be present in commercially available sources.

All percentages, ratios and proportions herein are by weight, unless otherwise specified. All temperatures are in degrees Celsius (° C.) unless otherwise specified. All measurements are in SI units unless otherwise specified. All documents cited are in relevant part, incorporated herein by reference.

Lipophilic Fluid Cleaning Compositions Having Bleaching Capabilities

In use versions of Applicants' cleaning compositions typically comprise a dispersion comprising at least a first and second phase. Said first phase is typically an aqueous phase and said second phase is typically a non-aqueous continuous phase that typically comprises a lipophilic fluid. Prior to undergoing the enzymatic reaction that generates peracid, said cleaning compositions typically comprise a peracid precursor, a hydrogen peroxide source, a pH adjuster, water, enzyme and a lipophilic fluid with any remaining balance being an optional/adjunct ingredients including but not limited to emulsifiers and chelants, or mixture thereof. Based on a liter of in use cleaning composition, the aforementioned materials may be present as follows: said peracid precursor may be present at levels of from about 0.001 moles per liter, from about 0.001 moles per liter to about 0.1 moles per liter, from about 0.005 moles per liter to about 0.05 moles per liter, or even from about 0.005 moles per liter to about 0.02 moles per liter; said source of hydrogen peroxide may be present at levels of from about 0.001 moles per liter, from about 0.001 moles per liter to about 0.1 moles per liter, from about 0.005 moles per liter to about 0.05 moles per liter, or even from about 0.005 moles per liter to about 0.02 moles per liter; said water may be present at levels sufficient to provide a mass ratio of hydrogen peroxide to water ratio of greater than about 4:1, greater than about 3:1, or even greater than about 2:1; said enzyme is typically present in a level sufficient to generate sufficient peracid when the enzyme is placed in intimate physical contact with the cleaning composition, such a level is typically 100-100,000 PLU as determined by the PLU assay that is supplied by the supplier of, Novozym 435™, Novozymes A/S-Krogshoejvej 36-2880 Bagsvaerd—Denmark, and said pH adjuster may be present at a level that is sufficient to provide an in use pH in the aqueous phase of the in use composition of from about 4 to about 10 and even from about 5 to about 9. As previously stated, any remaining balance of said composition is a lipophilic fluid, an optional/adjunct ingredients including but not limited to emulsifiers and chelants or mixture thereof. When present in said compositions, said emulsifier is present at levels of, from about 0.0025 moles per liter to about 0.03 moles per liter, from about 0.0025 moles per liter to about 0.025 moles per liter, or even from about 0.005 moles per liter to about 0.02 moles per liter; and said chelant is present at levels of from about 0.001 milli moles per liter to about 0.3 millimoles per liter, from about 0.001 millimoles per liter to about 0.15 millimoles per liter, or even from about 0.001 millimoles per liter to about 0.08 millimoles per liter.

Finished in use versions of Applicants' cleaning compositions may comprise from about 10 ppm to about 2,000 ppm, from about 30 ppm to about 1,000 ppm, or even from about 80 ppm to about 500 ppm of a peracid. In a 1 mL sample of said cleaning composition, greater than about 0.95 weight fraction of the first phase is contained in droplets, each droplet having an individual weight of less than 1 wt %, less than 0.5 wt %, and even less than 0.1 wt % of the total mass of the first phase in said 1 mL sample. For purposes of the present invention, droplet weight is determined according to ISO 13320-1 titled “Particle size analysis—Laser diffraction methods”. Said first phase may comprise, based on the total weight of peracid in said composition, from about 50% to about 100%, from about 95% to about 100% or even from about 99% to about 100%, of said cleaning composition's peracid.

Process of Making

In use versions of Applicants' cleaning compositions may be made by combining a bleaching composition comprising a peracid precursor, a hydrogen peroxide source, a pH adjuster and a suitable enzyme, or a pre-made mixture of such materials, or mixtures thereof with a lipophilic fluid in a manner such that the enzyme is in intimate contact with the preacid precursor and hydrogen peroxide source. In one aspect of the invention a cleaning composition comprising a dispersion comprising at least a first and second phase is formed. IN another aspect of the invention a cleaning composition comprising a dispersion comprising at least a first and second phase, wherein in a 1 mL sample of said cleaning composition, greater than about 0.95 weight fraction of the first phase is contained in droplets, each droplet having an individual weight of less than 1 wt %, less than 0.5 wt %, and even less than 0.1 wt % of the total mass of the first phase in said 1 mL sample, is formed. For purposes of the present invention, droplet weight is determined according to ISO 13320-1 titled “Particle size analysis—Laser diffraction methods”. As will be appreciated by the skilled artisan, such contact may be achieved by combining such materials in one solution or by making a solution of all the required materials except the enzyme and then pumping such solution through a cartridge that contains said enzyme. In another aspect of Applicants' invention said cartridge or other device comprising said enzyme may be placed directly in such solution. In another aspect of the invention said enzyme may be immobilized on a surface.

Method of Use

Items, including but not limited to fabrics, may be cleaned by contacting said item with an in use version of Applicants' lipophilic fluid cleaning composition having bleaching capabilities. As will be appreciated by the skilled artisan, contacting includes but is not limited to, immersion and spraying. Prior to application said cleaning composition may be allowed to react for a sufficient period of time to form a desired level of peracid. Typically, said item is contacted with said cleaning composition between 1 minute and 60 minutes after the components of said cleaning composition are combined to form said cleaning composition, between 2 minutes and 30 minutes after the components of said cleaning composition are combined to form said cleaning composition, or even between 5 minute and 20 minutes after the components of said cleaning composition are combined to form said cleaning composition.

Bleaching Compositions

Applicants have discovered that certain bleaching compositions are unexpectedly suitable for providing lipophilic fluid cleaning compositions with bleaching capabilities. Suitable bleaching compositions typically comprise a peracid precursor, a hydrogen peroxide source, an enzyme, and a pH adjuster with any remaining balance being a lipophilic fluid, an optional/adjunct ingredients including but not limited to emulsifiers and chelants, or mixture thereof. In one aspect of Applicants' invention the aforementioned materials may be provided as a mixture. In another aspect of Applicants' invention one or more the aforementioned materials may be packed with, but kept from coming in intimate contact with, the remaining materials, for example, the enzyme may be contained in a cartridge that is designed to retain said enzyme while at the same time allowing fluid to pass through said cartridge. When the aforementioned compositions have the form of a mixture, such mixture may be a solid or a fluid that may be made by combining the components listed above in the percentages listed below. Regardless of the form or packing of the composition, it is important that the enzyme be sufficiently separated from the peracid precursor such that undesired levels of peracid are not formed during manufacture, shipping and storage.

In the aforementioned bleaching compositions, the peracid precursor may be present at levels of from about 5%, from about 5% to about 60%, from about 10% to about 50%, or even from about 10% to about 25% by weight of the bleaching composition; the source of hydrogen peroxide may be present at levels of from about 5%, from about 5% to about 60%, from about 10% to about 50%, or even from about 10% to about 25% by weight of the bleaching composition; the enzyme may be present at levels of from about 5%, from about 5% to about 60%, from about 10% to about 50%, or even from about 10% to about 25% by weight of the bleaching composition; and the pH adjuster may be present at a level that is sufficient to provide an in use pH in an aqueous phase of the in use composition of from about 4 to about 10 and even from about 5 to about 9. As previously stated, any remaining balance of said composition is a lipophilic fluid, an optional/adjunct ingredients including but not limited to emulsifiers and chelants or mixture thereof. Said emulsifier is typically present at levels of from about 0% to about 60%, from about 5% to about 50%, or even from about 10% to about 40% by weight of the bleaching composition; and said chelant is typically present at levels of from about 0.001% to about 0.5%, from about 0.002% to about 0.2%, or even from about 0.002% to about 0.15% by weight of the bleaching composition.

The aforementioned bleaching compositions may be packaged in a kit containing instructions for use.

Materials

Suitable materials for making Applicants' lipophilic fluid cleaning compositions having bleaching capabilities and bleaching compositions are as follows:

Suitable preacid precursors include any carboxylic acid or its salt or its derived ester that can react with the enzyme and source of hydrogen peroxide to forming a stable peroxycarboxylic acid in the cleaning composition. Examples of suitable preacid precursors include, but are not limited to, carboxylic acids and their derivatives having carbon chain lengths of C₁-C₂₂ such formic acid, acetic acid, propionic acid, octanoic acid, decanoic acid, dodecanoic and tetradecanoic acid or their inorganic or organic salts, such as sodium aceteate or their esters formed with alcohols with carbon chain lengths of C₁-C₁₆; glycerol esters of the carboxylic acids, including but not limited to, triacetin, tripropyn, tributyrin, trioctanoin and triglycerides based on C₁₀-C₁₈ carboxylic acids.

Suitable sources of hydrogen peroxide include, but are not limited to, materials selected from the group consisting of perborate compounds, percarbonate compounds, perphosphate compounds, hydrogen peroxide, hydrogen peroxide solutions (having, for example, a solution strength of from about 20% to about 70% or from about 20 to about 36%), and mixtures thereof.

Enzymes may be described by their enzyme commissioning number see for example “Enzyme Nomenclature—1992” Academic Press, Inc. 1250 Sixth Avenue, San Diego, Calif. 92101-4311—published for the International Union of Biochemistry and Molecular Biology. Suitable enzymes include any enzyme that is sufficiently stable in the presence of suitable sources of hydrogen peroxide to efficiently catalyze a per-hydrolysis reaction of a suitable preacid precursor to form a sufficient amount of peroxycarboxylic-acid in the end use cleaning composition. Suitable enzymes include enzymes with the typical alpha-beta hydrolase folded protein 3D-structure. Examples of such enzymes are hydrolases found under enzyme commissioning number (E.C.) 3.1 acting on ester bonds, under E.C. 3.4 acting on peptide bonds and enzymes of E.C. 3.5 acting on carbon-nitrogen bonds other than peptide bonds. For example lipases, including E.C. 3.1.1.3 of Candida Antarctica, esterases and proteases may be useful. Novozym 435™ which is supplied by Novozymes A/S—Krogshoejvej 36-2880 Bagsvaerd—Denmark is an example of an enzyme that is useful in the present invention.

Suitable pH adjusters include, but are not limited to, inorganic and organic bases and salts of weak acids, for example, NaOH, KOH, and buffers based on citrate, phosphate and MEA, TEA, Tris-buffers.

Suitable chelants include organic phosphonates, amino carboxylates, polyfunctionally-substituted aromatic compounds, nitriloacetic acid and mixtures thereof. Organic phosphonates suitable for use as chelating agents in the compositions of the present invention, may be selected from ethylenediaminetetrakis(methylenephosphonates) available under the trademark DEQUEST™ from Solutia, diethylene triamine penta(methylene phosphonate), ethylene diamine tri(methylene phosphonate), hexamethylene diamine tetra(methylene phosphonate), α-hydroxy-2-phenyl ethyl diphosphonate, methylene diphosphonate,hydroxy 1,1-hexylidene, vinylidene 1,1 diphosphonate, 1,2 dihydroxyethane 1,1 diphosphonate and hydroxyethylene 1,1 diphosphonate. While not required, such amino phosphonates may not contain alkyl or alkenyl groups with more than 6 carbon atoms. Amino carboxylates chelating agents include ethylene-diaminetetracetates, ethylenediamine disuccinate, N-hydroxyethylethylenediamine triacetates, 2-hydroxypropylene diamine disuccinate, nitrilotriacetates, ethylenediamine tetraproprionates, triethylenetetraaminehexacetates, ethylene triamine pentaacetate, diethylenetriaminepentaacetates, and ethanoldiglycines, alkali metal, ammonium, and substituted ammonium salts and mixtures thereof. Certain amino carboxylates chelants for use herein are ethylenediamine disuccinate (“EDDS”), such as [S,S] isomer as described in U.S. Pat. No. 4,704,233, ethylenediamine-N,N′-diglutamate (EDDG) and 2-hydroxypropylenediamine-N,N′-disuccinate (HPDDS) compounds. Another suitable amino carboxylate chelant is ethylenediamine disuccinate. Poly-functionally-substituted aromatic chelating agents are also useful in the compositions herein. See U.S. Pat. No. 3,812,044. Certain compounds of this type in acid form are dihydroxydisulfobenzenes such as 1,2-dihydroxy-3,5-disulfobenzene. Such chelants include diphosphonate derivatives of the organic phosphonate chelants selected from α-hydroxy-2 phenyl ethyl diphosphonate, methylene diphosphonate, hydroxy 1,1-hexylidene, vinylidene 1,1 diphosphonate, 1,2dihydroxyethane 1,1 diphosphonate and hydroxyethylene 1,1 diphosphonate. Hydroxyethylene 1,1 diphosphonate is particularly useful.

Suitable emulsifiers may be selected from the group consisting of siloxane-based surfactants, anionic surfactants, nonionic surfactants, cationic surfactants, zwitterionic surfactants, ampholytic surfactants, semi-polar nonionic surfactants, gemini surfactants, amine surfactants, fluorosurfactants and mixtures thereof. The emulsifying agent/surfactant may be soluble in the lipophilic fluid.

One class of emulsifying agent/surfactant can include siloxane-based surfactants (siloxane-based materials) The siloxane-based surfactants in this application may be siloxane polymers for other applications. The siloxane-based surfactants typically have a weight average molecular weight from 500 to 20,000 daltons. Such materials, derived from poly(dimethylsiloxane), are well known in the art. In the present invention, not all such siloxane-based surfactants are suitable, because they do not provide improved cleaning of soils compared to the level of cleaning provided by the lipophilic fluid itself.

Suitable siloxane-based surfactants comprise a polyether siloxane having the formula:
MₐD_{b}D′_{c}D″_{d}M′₂₋ₐ
wherein a is 0-2; b is 0-1000; c is 0-50; d is 0-50, provided that a+c+d is at least 1;
M is R¹₃₋ₑXₑSiO_{1/2} wherein R¹ is independently H, or a monovalent hydrocarbon group, X is hydroxyl group, and e is 0 or 1;
M′ is R²₃SiO_{1/2} wherein R² is independently H, a monovalent hydrocarbon group, or (CH₂)_{f}(C₆Q₄)_{g}O—(C₂H₄O)ₕ—(C₃H₆O)ᵢ(CₖH₂ₖ)ⱼ—R³, provided that at least one R² is (CH₂)_{f}(C₆Q₄)_{g}O—(C₂H₄O)ₕ—(C₃H₆O)ᵢ(CₖH₂ₖ)ⱼ—R³, wherein R³ is independently H, a monovalent hydrocarbon group or an alkoxy group, f is 1-10, g is 0 or 1, h is 1-50, i is 0-50, j is 0-50, k is 4-8; C₆Q₄ is unsubstituted or substituted; Q is independently selected from H, C₁₋₁₀ alkyl, C₁₋₁₀ alkenyl, and mixtures thereof;
D is R⁴₂SiO_{2/2} wherein R⁴ is independently H or a monovalent hydrocarbon group;
D′ is R⁵₂SiO_{2/2} wherein R⁵ is independently R² provided that at least one R⁵ is (CH₂)_{f}(C₆Q₄)_{g}O—(C₂H₄O)ₕ—(C₃H₆O)ᵢ(CₖH₂ₖ)ⱼ—R³, wherein R³ is independently H, a monovalent hydrocarbon group or an alkoxy group, f is 1-10, g is 0 or 1, h is 1-50, i is 0-50, j is 0-50, k is 4-8; C₆Q₄ is unsubstituted or substituted; Q is independently selected from H, C₁-₁₀ alkyl, C₁-₁₀ alkenyl, and mixtures thereof; and
D″ is R⁶₂SiO_{2/2} wherein R⁶ is independently H, a monovalent hydrocarbon group or (CH₂)₁(C₆Q₄)ₘ(A)ₙ-[(L)ₒ-(A′)ₚ-]_{q}-(L′)ᵣZ(G)ₛ, wherein 1 is 1-10; m is 0 or 1; n is 0-5; o is 0-3; p is 0 or 1; q is 0-10; r is 0-3; s is 0-3; C₆Q₄ is unsubstituted or substituted; Q is independently selected from H, C₁₋₁₀ alkyl, C₁₋₁₀ alkenyl, and mixtures thereof; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof; L and L′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀ alkyl or alkenyl, a carbohydrate unsubstituted or substituted with a C₁₋₁₀ alkyl or alkenyl or an ammonium; G is an anion or cation such as H⁺, Na⁺, Li⁺, K⁺, NH₄⁺, Ca⁺², Mg⁺², Cl⁻, Br⁻, I⁻, mesylate or tosylate.

Examples of the types of siloxane-based surfactants described herein above may be found in EP-1,043,443A1, EP-1,041,189 and WO-01/34,706 (all to GE Silicones) and U.S. Pat. No. 5,676,705, U.S. Pat. No. 5,683,977, U.S. Pat. No. 5,683,473, and EP-1,092,803A1 (all assigned to Lever Brothers).

Non-limiting commercially available examples of suitable siloxane-based surfactants are TSF 4446 (ex. General Electric Silicones), XS69-B5476 (ex. General Electric Silicones); Jenamine HSX (ex. DelCon) and Y12147 (ex. OSi Specialties).

Another class of suitable emulsifying agent/surfactant is anionic surfactants. Non-limiting examples of anionic surfactants useful herein include:
a) C₁₁-C₁₈ alkyl benzene sulfonates (LAS);
b) C₁₀-C₂₀ primary, branched-chain and random alkyl sulfates (AS);
c) C₁₀-C₁₈ secondary (2,3) alkyl sulfates having formula (I) and (II): 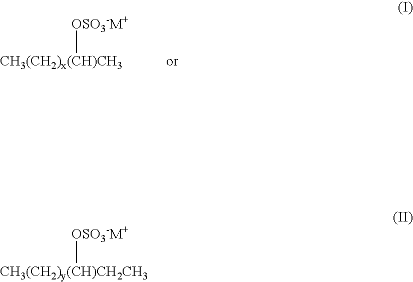
   M in formula (I) and (II) is hydrogen or a cation which provides charge neutrality. For the purposes of the present invention, all M units, whether associated with a surfactant or adjunct ingredient, can either be a hydrogen atom or a cation depending upon the form isolated by the artisan or the relative pH of the system wherein the compound is used. Non-limiting examples of preferred cations include sodium, potassium, ammonium, and mixtures thereof. Wherein x in formula (I) and (II) is an integer of at least about 7, preferably at least about 9; y in formula (I) and (II) is an integer of at least 8, preferably at least about 9;
d) C₁₀-C₁₈ alkyl alkoxy sulfates (AEₓS) wherein preferably x is from 1-30;
e) C₁₀-C₁₈ alkyl alkoxy carboxylates preferably comprising 1-5 ethoxy units;
f) mid-chain branched alkyl sulfates as discussed in U.S. Pat. No. 6,020,303 and U.S. Pat. No. 6,060,443;
g) mid-chain branched alkyl alkoxy sulfates as discussed in U.S. Pat. No. 6,008,181 and U.S. Pat. No. 6,020,303;
h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548.;
i) C₁₂-C₂₀ methyl ester sulfonate (MES);
i) C₁₀-C₁₈ alpha-olefin sulfonate (AOS); and
k) C₆-C₂₀ Sulfosuccinates available under the trade names of Aerosol OT and Aerosol TR-70 (ex. Cytec).

Another class of suitable emulsifying agent/surfactant is nonionic surfactants. Non-limiting examples of nonionic surfactants include:
a) C₁₂-C₁₈ alkyl ethoxylates, such as, NEODOL® nonionic surfactants from Shell;
b) C₆-C₁₂ alkyl phenol alkoxylates wherein the alkoxylate units are a mixture of ethyleneoxy and propyleneoxy units;
c) C₁₂-C₁₈ alcohol and C₆-C₁₂ alkyl phenol condensates with ethylene oxide/propylene oxide block polymers such as Pluronic® from BASF;
d) C₁₄-C₂₂ mid-chain branched alcohols, BA, as discussed in U.S. Pat. No. 6,150,322;
e) C₁₄-C₂₂ mid-chain branched alkyl alkoxylates, BAEₓ, wherein x is from 1-30, as discussed in U.S. Pat. No. 6,153,577, U.S. Pat. No. 6,020,303 and U.S. Pat. No. 6,093,856;
f) Alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779;
g) Polyhydroxy fatty acid amides as discussed in U.S. Pat. No. 5,332,528, WO 92/06162, WO 93/19146, WO 93/19038, and WO 94/09099;
h) ether capped poly(oxyalkylated) alcohol surfactants as discussed in U.S. Pat. No. 6,482,994 and WO 01/42408; and

Further non-limiting examples include nonionic surfactants selected from the group consisting of fatty acid (C₁₂-₁₈) esters of ethoxylated (EO₅₋₁₀₀) sorbitans. More preferably said surfactant is selected from the group consisting of mixtures of laurate esters of sorbitol and sorbitol anhydrides; mixtures of stearate esters of sorbitol and sorbitol anhydrides; and mixtures of oleate esters of sorbitol and sorbitol anhydrides. Even more preferably said surfactant is selected from the group consisting of Polysorbate 20, which is a mixture of laurate esters of sorbitol and sorbitol anhydrides consisting predominantly of the monoester, condensed with about 20 moles of ethylene oxide; Polysorbate 60 which is a mixture of stearate esters of sorbitol and sorbitol anhydride, consisting predominantly of the monoester, condensed with about 20 moles of ethylene oxide; Polysorbate 80 which is a mixture of oleate esters of sorbitol and sorbitol anhydrides, consisting predominantly of the monoester, condensed with about 20 moles of ethylene oxide; and mixtures thereof. Most preferably, said surfactant is Polysorbate 60.

Other examples of ethoxylated surfactant include carboxylated alcohol ethoxylate, also known as ether carboxylate, having a general structure: R⁷O(CHCH₂O)ₛ—CO₂H; wherein R⁷ having from about 8 to about 20 carbon atoms and s being and average from about 0.1 to about 10; ethoxylated quaternary ammonium surfactants, such as PEG-5 cocomonium methosulfate, PEG-15 cocomonium chloride, PEG-15 oleammonium chloride and bis(polyethoxyethanol)tallow ammonium chloride. Other suitable nonionic ethoxylated surfactants are ethoxylated alkyl amines derived from the condensation of ethylene oxide with hydrophobic alkyl amines, with R⁸ having from about 8 to about 22 carbon atoms and s being from about 3 to about 30.

Another class of suitable emulsifying agent/surfactant is cationic surfactants. Non-limiting examples of cationic surfactants include: the quaternary ammonium surfactants, which can have up to 26 carbon atoms.
a) alkoxylate quaternary ammonium (AQA) surfactants as discussed in U.S. Pat. No. 6,136,769;
b) dimethyl hydroxyethyl quaternary ammonium as discussed in U.S. Pat. No. 6,004,922;
c) polyamine cationic surfactants as discussed in WO 98/35002, WO 98/35003, WO 98/35004, WO 98/35005, and WO 98/35006;
d) cationic ester surfactants as discussed in U.S. Pat. Nos. 4,228,042, 4,239,660 4,260,529 and U.S. Pat. No. 6,022,844; and
e) amino surfactants as discussed in U.S. Pat. No. 6,221,825 and WO 00/47708, specifically amido propyldimethyl amine.

Another class of suitable emulsifying agent/surfactant is zwitterionic surfactants. Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylammino-1-propane sulfonate where the alkyl group can be C₈ to C₁₈, preferably C₁₀ to C₁₄.

Another class of suitable emulsifying agent/surfactant is ampholytic surfactants. Non-limiting examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 to Laughlin et al., issued Dec. 30, 1975 at column 19, lines 18-35, for examples of ampholytic surfactants.

Another class of suitable emulsifying agent/surfactant is semi-polar nonionic surfactants Non-limiting examples of semi-polar nonionic surfactants include: water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms. See WO 01/32816, U.S. Pat. No. 4,681,704, and U.S. Pat. No. 4,133,779.

Another class of suitable emulsifying agent/surfactant is gemini surfactants. Gemini Surfactants are compounds having at least two hydrophobic groups and at least two hydrophilic groups per molecule have been introduced. These have become known as “gemini surfactants” in the literature, e.g., Chemtech, March 1993, pp 30-33, and J. American Chemical Soc., 115, 10083-10090 (1993) and the references cited therein.

Another class of suitable emulsifying agent/surfactant is amine surfactants. Non-limiting examples of amine surfactants include primary alkylamines comprising from about 6 to about 22 carbon atoms are used. Particularly preferred primary alkylamines are oleylamine (commercially available from Akzo under the trade name ARMEEN OLD®), dodecylamine (commercially available from Akzo under the trade name ARMEEN 12D®), branched C₁₆-C₂₂ alkylamine (commercially available from Rohm & Haas under the trade name PRIMENE JM-T®) and mixtures thereof.

Another class of suitable emulsifying agent/surfactant is fluorosurfactants. Fluorosurfactants also may be used as the emulsifier in the present invention. Suitable fluorosurfactants include, anionic fluorosurfactants, including but not limited to fluoroalkyl carboxylates, fluoroalkyl phosphates, fluoroalkyl sulfates; nonionic fluorosurfactants, including but not limited to fluoroalkyl ethoxylates; cationic fluorosurfactants, including but not limited to quaternary ammonium salts; and amphoteric fluorosurfactants, including but not limited to betaine. Preferred fluorosurfactants are available from the DUPONT® Company under the tradename ZONYL®, 3M® under the tradename FLUORAD®, and CLARIANT® under the tradename FLUOWET®.

As used herein, “lipophilic fluid” means any liquid or mixture of liquid that is immiscible with water at up to 20% by weight of water. In general, a suitable lipophilic fluid can be fully liquid at ambient temperature and pressure, can be an easily melted solid, e.g., one which becomes liquid at temperatures in the range from about 0° C. to about 60° C., or can comprise a mixture of liquid and vapor phases at ambient temperatures and pressures, e.g., at 25° C. and 1 atm. of pressure.

It is preferred that the lipophilic fluid herein be inflammable or, have relatively high flash points and/or low VOC characteristics, these terms having conventional meanings as used in the dry cleaning industry, to equal or, preferably, exceed the characteristics of known conventional dry cleaning fluids.

Non-limiting examples of suitable lipophilic fluid materials include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

“Siloxane” as used herein means silicone fluids that are non-polar and insoluble in water or lower alcohols. Linear siloxanes (see for example U.S. Pat. Nos. 5,443,747, and 5,977,040) and cyclic siloxanes are useful herein, including the cyclic siloxanes selected from the group consisting of octamethyl-cyclotetrasiloxane (tetramer), dodecamethyl-cyclohexasiloxane (hexamer), and preferably decamethyl-cyclopentasiloxane (pentamer, commonly referred to as “D5”). A preferred siloxane comprises more than about 50% cyclic siloxane pentamer, more preferably more than about 75% cyclic siloxane pentamer, most preferably at least about 90% of the cyclic siloxane pentamer. Also preferred for use herein are siloxanes that are a mixture of cyclic siloxanes having at least about 90% (preferably at least about 95%) pentamer and less than about 10% (preferably less than about 5%) tetramer and/or hexamer.

The lipophilic fluid can include any fraction of dry-cleaning solvents, especially newer types including fluorinated solvents, or perfluorinated amines. Some perfluorinated amines such as perfluorotributylamines, while unsuitable for use as lipophilic fluid, may be present as one of many possible adjuncts present in the lipophilic fluid-containing composition.

Other suitable lipophilic fluids include, but are not limited to, diol solvent systems e.g., higher diols such as C₆ or C₈ or higher diols, organosilicone solvents including both cyclic and acyclic types, and the like, and mixtures thereof.

Non-limiting examples of low volatility non-fluorinated organic solvents include for example OLEAN® and other polyol esters, or certain relatively nonvolatile biodegradable mid-chain branched petroleum fractions.

Non-limiting examples of glycol ethers include propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether.

Non-limiting examples of other silicone solvents, in addition to the siloxanes, are well known in the literature, see, for example, Kirk Othmer's Encyclopedia of Chemical Technology, and are available from a number of commercial sources, including GE Silicones, Toshiba Silicone, Bayer, and Dow Corning. For example, one suitable silicone solvent is SF-1528 available from GE Silicones.

Non-limiting examples of glycerine derivative solvents include materials having the following structure:

Non-limiting examples of suitable glycerine derivative solvents for use in the methods and/or apparatuses of the present invention include glyercine derivatives having the following structure: 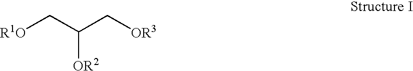
wherein R¹, R² and R³ are each independently selected from: H; branched or linear, substituted or unsubstituted C₁-C₃₀ alkyl, C₂-C₃₀ alkenyl, C₁-C₃₀ alkoxycarbonyl, C₃-C₃₀ alkyleneoxyalkyl, C₁-C₃₀ acyloxy, C₇-C₃₀ alkylenearyl; C₄-C₃₀ cycloalkyl; C₆-C₃₀ aryl; and mixtures thereof. Two or more of R¹, R² and R³ together can form a C₃-C₈ aromatic or non-aromatic, heterocyclic or non-heterocyclic ring.

Non-limiting examples of suitable glycerine derivative solvents include 2,3-bis(1,1-dimethylethoxy)-1-propanol; 2,3-dimethoxy-1-propanol; 3-methoxy-2-cyclopentoxy-1-propanol; 3-methoxy-1-cyclopentoxy-2-propanol; carbonic acid (2-hydroxy-1-methoxymethyl)ethyl ester methyl ester; glycerol carbonate and mixtures thereof.

Non-limiting examples of other environmentally-friendly solvents include lipophilic fluids that have an ozone formation potential of from about 0 to about 0.31, lipophilic fluids that have a vapor pressure of from about 0 to about 0.1 mm Hg, and/or lipophilic fluids that have a vapor pressure of greater than 0.1 mm Hg, but have an ozone formation potential of from about 0 to about 0.31. Non-limiting examples of such lipophilic fluids that have not previously been described above include carbonate solvents (i.e., methyl carbonates, ethyl carbonates, ethylene carbonates, propylene carbonates, glycerine carbonates) and/or succinate solvents (i.e., dimethyl succinates).

As used herein, “ozone reactivity” is a measure of a VOC's ability to form ozone in the atmosphere. It is measured as grams of ozone formed per gram of volatile organics. A methodology to determine ozone reactivity is discussed further in W. P. L. Carter, “Development of Ozone Reactivity Scales of Volatile Organic Compounds”, Journal of the Air & Waste Management Association, Vol. 44, Pages 881-899, 1994. “Vapor Pressure” as used can be measured by techniques defined in Method 310 of the California Air Resources Board.

Preferably, the lipophilic fluid comprises more than 50% by weight of the lipophilic fluid of cyclopentasiloxanes, (“D5”) and/or linear analogs having approximately similar volatility, and optionally complemented by other silicone solvents.

Optional/Adjunct Ingredients

While not essential for the purposes of the present invention, the non-limiting list of optional ingredient illustrated hereinafter are suitable for use in the instant cleaning compositions and may be desirably incorporated in certain embodiments of the invention, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the composition and the nature of the cleaning operation for which it is to be used. Suitable adjunct materials include, but are not limited to, additional surfactants, builders, dye transfer inhibiting agents, dispersants, additional enzymes, and enzyme stabilizers, catalytic metal complexes, polymeric dispersing agents, clay soil removal/anti-redeposition agents, brighteners, suds suppressors, dyes, perfumes, structure elasticizing agents, fabric softeners, carriers, hydrotropes, processing aids and/or pigments. Examples of optional/adjunct ingredients and levels of use are found in U.S. Pat. Nos. 5,576,282, 6,306,812 B1 and 6,326,348 B1 that are incorporated by reference.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A cleaning composition having at least a first phase and a second phase, said composition comprising:
a.) from about 0.001 moles per liter of a peracid precursor;
b.) from about 0.001 moles per liter of a source of hydrogen peroxide;
c.) a sufficient amount of water to provide a mass ratio of hydrogen peroxide to water of greater than 4:1;
d.) a sufficient amount of enzyme to provide an enzyme activity of from about 100 to about 100,000 PLU, said enzyme being an enzyme that is sufficiently stable in the presence of a source of hydrogen peroxide to efficiently catalyze a per-hydrolysis reaction of a preacid precursor to form peroxycarboxylic-acid; and
e.) a sufficient amount of pH adjuster to provide the first phase with a pH of from about 4 to about 10;
the balance of said cleaning composition comprising a lipophilic fluid or a lipophilic fluid and an adjunct ingredient.

2. A cleaning composition having at least a first phase and a second phase, said composition comprising:
a.) from about 0.001 moles per liter to about 0.1 moles per liter of a peracid precursor;
b.) from about 0.001 moles per liter to about 0.1 moles per liter of a source of hydrogen peroxide;
c.) a sufficient amount of water to provide a mass ratio of hydrogen peroxide to water of greater than 4:1;
d.) a sufficient amount of enzyme to provide an enzyme activity of from about 100 to about 100,000 PLU, said enzyme being an enzyme that is sufficiently stable in the presence of a source of hydrogen peroxide to efficiently catalyze a per-hydrolysis reaction of a preacid precursor to form peroxycarboxylic-acid; and
e.) a sufficient amount of pH adjuster to provide the first phase with a pH of from about 4 to about 10
the balance of said cleaning composition comprising a lipophilic fluid or a lipophilic fluid and an adjunct ingredient.

3. The cleaning composition of claim 2 wherein said enzyme is sufficiently separated from said preacid precursor or said hydrogen peroxide such that the enzymatic reaction that results in the generation of peracid does not substantially occur.

4. The cleaning composition of claim 2 wherein said enzyme comprises an enzyme having an enzyme commissioning number of 3.1, enzyme commissioning number of 3.4, enzyme commissioning number of 3.5, and mixtures thereof.

5. The cleaning composition of claim 4 wherein said enzyme comprises an enzyme having an enzyme commissioning number of 3.1.1.3.

6. The cleaning composition of claim 2 wherein said enzyme is not in intimate contact with said preacid precursor or said hydrogen peroxide.

7. The cleaning composition of claim 2 comprising an adjunct ingredient.

8. The cleaning composition of claim 2 wherein said adjunct ingredient is a material selected from an emulsifer or a chelant.

9. The cleaning composition of claim 2 wherein said lipophilic fluid comprises decamethylcyclopentasiloxane.

10. The cleaning composition of claim 2 comprising:
a.) from about 0.005 moles per liter to about 0.05 moles per liter of a peracid precursor;
b.) from about 0.005 moles per liter to about 0.05 moles per liter of a source of hydrogen peroxide;
c.) a sufficient amount of water to provide a mass ratio of hydrogen peroxide to water of greater than 3:1;
d.) a sufficient amount of enzyme to provide an enzyme activity of from about 100 to about 100,000 PLU, said enzyme comprising an enzyme having an enzyme commissioning number of 3.1, enzyme commissioning number of 3.4, enzyme commissioning number of 3.5, and mixtures thereof; and
e.) a sufficient amount of pH adjuster to provide the first phase with a pH of from about 5 to about 9;
the balance of said cleaning composition comprising a lipophilic fluid or a lipophilic fluid and an adjunct ingredient.

11. The cleaning composition of claim 10 comprising
a.) from about 0.005 moles per liter to about 0.02 moles per liter of a peracid precursor;
b.) from about 0.005 moles per liter to about 0.02 moles per liter of a source of hydrogen peroxide;
c.) a sufficient amount of water to provide a mass ratio of hydrogen peroxide to water of greater than 2:1;
d.) a sufficient amount of enzyme to provide an enzyme activity of from about 100 to about 100,000 PLU, said enzyme comprising an enzyme having an enzyme commissioning number of 3.1.13; and
e.) a sufficient amount of pH adjuster to provide the first phase with a pH of from about 5 to about 9;
the balance of said cleaning composition comprising a lipophilic fluid or a lipophilic fluid and an adjunct ingredient.

12. The cleaning composition of claim 2 wherein said enzyme is packaged in a cartridge.

13. The cleaning composition of claim 2 to wherein said enzyme is immobilized.

14. The cleaning composition of claim 5 comprising an adjunct material selected from the group consisting of builders, dye transfer inhibiting agents, dispersants, enzymes, and enzyme stabilizers, catalytic metal complexes, polymeric dispersing agents, clay soil removal/anti-redeposition agents, brighteners, suds suppressors, dyes, perfumes, structure elasticizing agents, fabric softeners, carriers, hydrotropes, processing aids, pigments and mixtures thereof.

15. A process of making a cleaning composition, said process comprising the steps of:
a.) providing a mixture comprising a preacid precursor, a source of hydrogen peroxide, water, a pH adjuster and a lipophilic fluid; and
b.) exposing the mixture of Step (a), for a sufficient period of time, to an enzyme that is sufficiently stable in the presence of said hydrogen peroxide to efficiently catalyze a per-hydrolysis reaction of said peracid precursor to form a peracid.

16. The process of claim 15 wherein in Step (b) said enzyme is immobilized.

17. The process of claim 15 wherein in Step (b) said enzyme isconatined in a cartridge.

18. The process of claim 15 wherein said enzyme comprises an enzyme having an enzyme commissioning number of 3.1, enzyme commissioning number of 3.4, enzyme commissioning number of 3.5, and mixtures thereof.

19. The process of claim 15 wherein said lipophilic fluid comprises decamethylcyclopentasiloxane.

20. A method of cleaning a fabric or hard surface said method comprising the step of contacting said surface with the cleaning composition of claim 2.

21. A kit comprising:
a.) instructions for making a cleaning composition; and
b.) a material selected from the group consisting of a peracid precursor, a source of hydrogen peroxide, a pH adjuster, an enzyme and mixtures thereof, when present in said kit, said enzyme being packaged such that said enzyme is not in intimate physical with said peracid precursor or said source of hydrogen peroxide.

22. A kit according to claim 20 comprising an enzyme said enzyme comprising an enzyme having an enzyme commissioning number of 3.1, enzyme commissioning number of 3.4, enzyme commissioning number of 3.5, and mixtures thereof.
